(19) United States
(12) Patent Application Publication
(10) Pub. No.: US 2012/0029982 A1
(43) Pub. Date: Feb. 2, 2012

(54) System for the registration, compensation, management and analysis of product or content customized purchase or selling

(76) Inventor: Antonio Andrade, Sao Juliao do Tojal (PT)

(21) Appl. No.: 13/258,456

(22) PCT Filed: Mar. 24, 2010
(86) PCT No.: PCT/IB10/51273

§ 371 Date: Sep. 22, 2011

(30) Foreign Application Priority Data
Mar. 24, 2009 (PT) 10410

(51) Int. Cl. G06Q 30/00

(52) U.S. Cl. 705/14.1; 705/26.1

(57) ABSTRACT

The present invention refers to the customization of generic product and/or content purchase and/or offering, either comprising or not a social responsibility parameter by means of a system comprising the incorporation of a key, designated token, which solely identifies each item of said products. By means of an adequate incentive such as rendering a specific offer, the purchaser and/or recipient of the offer, will use this key to personally identify himself before the system, namely by means of a proper site on the Internet, through telephone line, SMS, MMS, WAP, among others. The present invention describes a system, database and co-related methods allowing the said functionality. By means of this identification it is possible to convert generic product and/or content purchase and/or offering, either with or without a social responsibility parameter, into totally identified transactions, thus generating information and allowing its valorization and promotion.

### TECHNICAL DOMAIN OF THE INVENTION

The present invention refers to a system for registration, compensation, management and analysis of generic product or content customized purchase or selling, with or without a social responsibility parameter, through an unique identification of each item by means of a key, designated token, and by means of managing the information obtained from said key.

### GENERAL DESCRIPTION OF THE INVENTION

The present invention describes a solution for the customized purchase and/or offering of generic products and contents, with or without a social responsibility parameter, by means of a system comprising the incorporation of a key, designated token which identifies solely each item of those products.

By means of an adequate incentive such as rendering a specific offer, the purchaser and/or recipient of the offer (B2B-Business to Business) will use this key to personally identify himself before the system, namely by means of a proper site on the Internet, or through telephone line (Contact Center), mobile phone (Mobile Marketing), SMS, MMS, WAP, letter (Direct Marketing), and/or any other communication means and/or personally at the sales outlet by means of filling in a questionnaire.

The present invention describes a system, database and co-related methods allowing the said functionality.

By means of this identification it is possible to convert product and/or content generic purchase and/or offering, either into totally identified transactions, thus generating information allowing its valorization and promotion, including a social responsibility parameter.

### DESCRIPTION OF THE DRAWINGS

For an improved understanding of the invention, drawings are enclosed hereto, which illustrate preferential embodiments of the invention not aiming however to limit the scope of the present invention.

FIGS. 1, 2: Schematic representation (non-inclusive or mandatory) of the cycle for product and/or content purchase and/or offering, with or without a social responsibility parameter, offer rendering, identification and registration before the system, customized additional-value proposal.

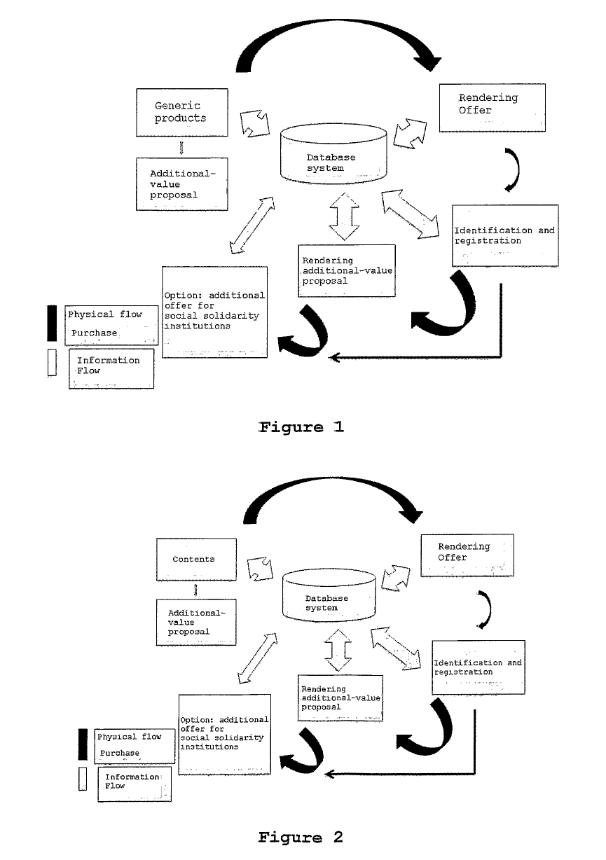

FIGS. 3, 4: Schematic representation (non-inclusive or mandatory) of the information centrally registered and processed by the system of the present invention.

FIGS. 5, 6: Schematic representation (non-inclusive or mandatory) of the associated partners and respective information exchange based on the system of the present invention.

The present invention includes providing conventional physical products with a key, designated token, which identifies solely each item. That is, from said token it is possible to identify, not only the category and product, but also the item in question.

This way, each code is mandatorily unique consequently identifying a purchaser and/or offer recipient, a transaction, a salesperson and an item of a specific product.

Specification: Contents (CD, DVD'S, Games, UMD, etc.)

This possibility is highly interesting for products carrying contents because, besides the frequent contents in standard and normal physical supports (CD, DVD, GAMES, Blue-Ray, UMD, among others) and normally used to market such contents in delivering channels, there is the possibility to add VALUE and/or information to these content delivering supports with the additional and integrated offer of Additional Experiences (Example: concert ticket, Preferential sites, etc.) and customer loyalty development instruments (Example: offers, discounts, coupons—additional vouchers, and access to restricted-member club), only accessible to those purchasing such content delivery support, by means of the said token.

As previously described, each content delivering support requires a different code and/or unique numbering allowing the final consumer to have access to said offers. The access to the these additional offers can be pursued in a technological platform (Web, Wap, etc.), directly at a sales outlet, but always by presenting a physical or digital evidence (the said token).

The final Consumer can also have access to unique experiences (e.g., preferential seats in a concert, access to after party—post-concert private party) by presenting this physical and/or digital evidence.

This physical and/or digital evidence can also be the evidence of club membership and can be an interface between the manufacturer and the final consumer.

It is further possible for the final consumer to decide on offering the value of his offers, contact value in the database, value regarding additional purchases and/or providing indication of other potential purchasers to social solidarity institutions exempt from any increment costs.

An example of a generic product and/or content offer, with or without social responsibility parameter, would be a watch, a T-shirt or a CD offered by a telecommunication company, thus allowing the offer recipient, upon token rendering and registration on the database, to obtain additional experiences (Ex.: Access tickets for concerts sponsored by the company, VIP seats, etc.), club membership and/or exclusive offers and discounts, explanatory video on product ‘use’, exclusive offers and discounts in Products and Offers of the said company and/or partners thereof, etc.

The ordering and numbering of each support and/or offer can be carried out by individually customizing a pamphlet, distich, label and/or card. The number or code of the token can also be printed in the product itself (for instance, book cover) or inclusively be obtained by electronic means (SMS, web, etc. . . . ), but it will always be unique and unrepeatable.

The recipient of this business offer (generic product and/or content) might also decide on offering the value of his additional offers, contact value in the database, value regarding additional purchases and/or providing indication of other potential purchasers to social solidarity institutions.

This way, when the final consumer purchases and/or receives and renders these customized generic product and/or content offers, he is not only buying products and/or contents in a physical support, but is also buying and benefiting from the possibility to access additional experiences, to improve his consumption experiences, to become a member of a community and loyalty program, to have access to a series of offers and relevant discounts and to contribute for society through relevant acts and/or actions in a mutually beneficial relationship with the entity to whom the product/service was purchased.

Token Mechanism

1. Token, for instance through unique card, ordered, numbered and interconnected, in either physical or digital format.

2. Printing of a unique, ordered, numbered and interconnected number, in either physical or digital format, onto the physical support itself, onto the content, product and/or service.

Limited Access Accessible by the Token

The final consumer has access to these advantages, through:

1. Technological platforms: Web, Wap, SMS, telephone, Bluetooth, Wi-Fi, RF, RF-ID and/or other means that might come to be created.

2. Sales Outlet by presenting the physical support wherein the unique number is written or engraved.

3. Specific sites and/or events wherein these advantages are available for rendering.

Benefits for the Final Consumer/Offer Recipient

1. Access to additional exclusive Experiences and Services—sales outlet, on-line

2. Explanatory Video of Product use

3. Personalized advisory

4. Subscription in Loyalty Programs

5. Special offers

6. Special discounts

7. Possibility to offer and contribute to social solidarity institutions, exempt from increment costs.

Specification: BOOK/Magazine Contents (selling to final consumer and/or offer, with or without social responsibility parameter)

For instance, in the case of purchasing a book or magazine, the final consumer has access to:
‘Loyalty Program’ Membership
Detailed information on constant contents in the book or magazine.

Therefore, the final consumer has the possibility to thoroughly deepen the contents of his outmost interest (on-line, telephone, etc.):
Videos, interviews
Access to Merchandising
Exhibitions, Congresses, Interviews, etc.

The company owning the contents has the possibility to generate additional incomes since the Token might have a limited duration (Time and or no. of access situations and accessible information, without incurring any increment costs).

Information Management and Analysis

By interconnecting the code with a specific product, for instance a specific CD, it is possible to access information on multiple CDs, products, downloads, etc.

This way, it is possible to perform a purchase profile, as well as a profile for additional uses/renderings/experiences inherent to a user, even if among different products, from different manufacturers, and among non-related sales outlets.

Naturally, the individual anonymity of the user can be guaranteed, depending on the option of the user or on the conditions underlying the accomplished offers.

Database management can be performed by a third party which guarantees contact and profile anonymity and which proceeds with selling the database, upon authorization of all parties involved including that of the final consumer.

By means of the solution herein set forth, it is possible to convert an unknown consumer and/or offer recipient into a loyalty-secured buyer/consumer having a strong relationship, given that this connection crosses beyond the boundaries of the individual product, sales outlet and of the manufacturer itself, associating individual purchase performances within a single profile.

It is also possible to undertake up selling and cross selling actions with products from the company and its partners, always with the final consumer's agreement.

The database itself can be marketed with other partners, upon agreement of all parties involved, as described below.

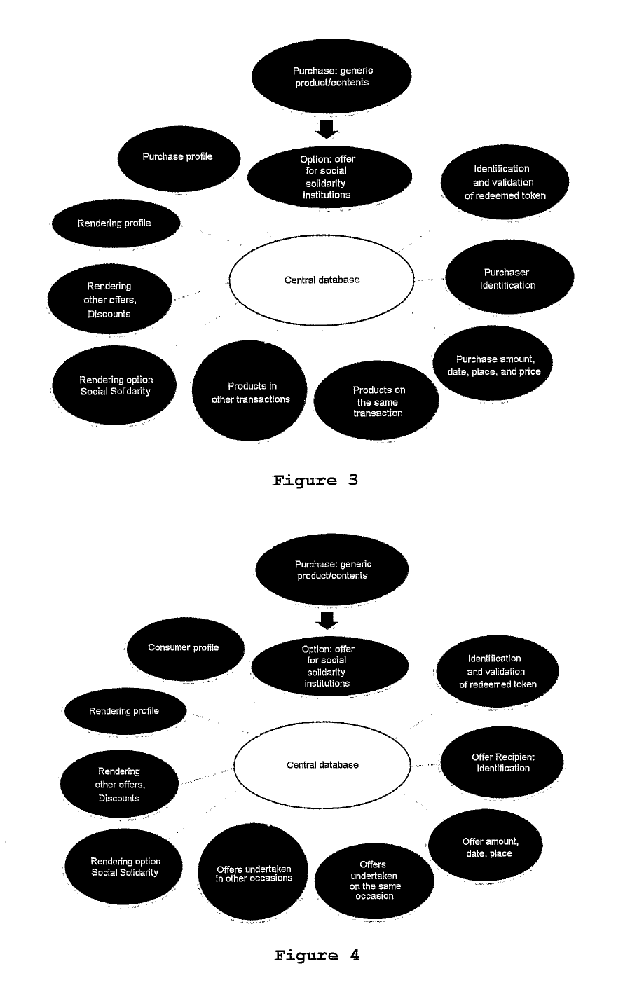

This profile is valuable due to the information made accessible, as described in FIG. 3 or 4.

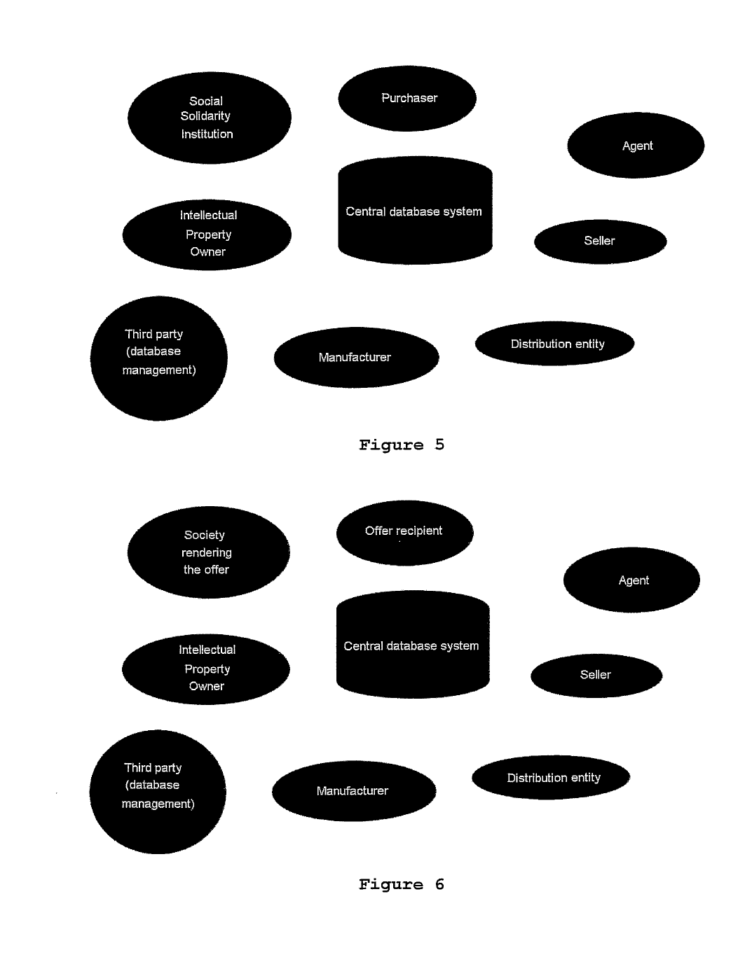

Finally, FIGS. 5 and 6 describe how the information is shared among the different partners of the system.

Depending on the authorization by the consumer and on the agreements between salesperson (sales outlet), agent (sales promoter), distribution entity (connection between manufacturer and salesperson) and the own manufacturer (responsible for the product/service in itself) and Social Solidarity institution, the information is shared among the parties, or not.

Depending on the authorization by the offer recipient and on the agreements between Society rendering the offer, salesperson (sales outlet and Offer Place), agent (sales promoter), distribution entity (connection between manufacturer and salesperson) and the own manufacturer (responsible for the product/service in itself) and Social Solidarity institution, the information is shared among the parties, or not.

So being, for instance, two manufacturers may agree to exchange their particular information, or a distribution entity may sell or rent the information to a manufacturer having interest in a new market. Finally, and still depending on the executed agreements, the entity being responsible for managing the own system may sell and/or rent the information on commissioning, the main value being allocated for the respective owner.

1. System for the registration, compensation, management and analysis of product or content customized purchase or selling comprising:
a) the incorporation in each item of a code or unique numbering identifying it in a central system;
b) the collection of said code or numbering, after the buyer or offer recipient has inserted the respective item;
c) the registration of user data in the database, the data allowing to be altered in terms of complexity, comprising name, telephone or cell phone;
d) the correlation of said code among different transactions by the same user;
e) the conversion of individual transactions into a customized purchase pattern.

2. System according to claim 1 wherein it motivates the insertion of the code or numbering by means of awarding the user with a prize, compensation or association, in particular experiences, offers, prices and individual discounts, converting the said awards into a customized awarding pattern.

3. System according to claim 1 wherein, by means of code and numbering insertion and registration in the database, it provides the final consumer with the possibility to assign monetary and/or service contributions to social solidarity institutions exempt from surcharge for the final consumer, the value of the contribution being set by the final consumer among several values and selections which are defined by the entity offering said values.

4. System according to claim 1 wherein it allows the insertion of code, numbering and rendering thereof by means of:
a) technological platforms, in particular Web, Wap, SMS, telephone, Bluetooth, Wi-Fi, RF, RF-ID, or
b) presentation at the sales outlet of physical support showing written or engraved code or unique number, or
c) specific places and/or events wherein the said offers will be available for rendering.

5. System according to claim 1 wherein each item is given a code or unique numbering by means of:
a) inserting an unique, serial, numbered and interconnected card, either in physical or digital format or,
b) printing an unique, serial, numbered and interconnected number, either in physical or digital format, onto the said physical support, content, product and/or service.
